(19) United States
(12) Patent Application Publication
(10) Pub. No.: US 2014/0096180 A1
(43) Pub. Date: Apr. 3, 2014

(54) SYSTEM, DEVICES, AND METHODS FOR PROXIMITY-BASED PARENTAL CONTROLS

(71) Applicants: Ansuya Negi, Beaverton, OR (US); Erik J. Johnson, Portland, OR (US)

(72) Inventors: Ansuya Negi, Beaverton, OR (US); Erik J. Johnson, Portland, OR (US)

(21) Appl. No.: 13/631,449

(22) Filed: Sep. 28, 2012

(51) Int. Cl. G06F 21/00

(52) U.S. Cl. 726/1; 726/4

(57) ABSTRACT

Systems, devices, and methods for proximity-based parental controls include a dominant computing device and a subordinate computing device configured to pair and establish a shared secret. Later, upon determining that the dominant computing device and the subordinate computing device are in proximity, the dominant computing device authenticates the subordinate computing device using the shared secret and authorizes access to an application on the subordinate computing device. The dominant computing device may configure an access control policy associated with the application. The access control policy may define allowed usage time, allowed usage time of day, allowed content, and/or other parameters. The subordinate computing device may enforce the access control policy. The application on the subordinate computing device may be a user interface shell, a game, a web browser, a particular web site, or other application. Other embodiments are described and claimed.

### BACKGROUND

Parents may wish to supervise and administer their children's usage of computing devices. Some computing devices provide parental controls that allow the parent to define and enforce allowed usage for another user—typically, a child. Such devices that typically incorporate local parental controls include video game consoles, television set-top boxes, video players, smart phones, tablet computers, notebooks, and other computing devices. Parental controls allow the parent to restrict certain usage of the computing device; for example, to restrict use of certain applications, restrict display of certain content, and/or restrict time usage. Content may be restricted according to ratings systems adopted for television, movies, and video games. Parental controls typically only allow the parent to administer settings on the device itself, which may be password-protected.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for proximity-based parental controls;

FIG. 2 is a simplified block diagram of at least one embodiment of an environment of a parent computing device of the system of FIG. 1;

FIG. 3 is a simplified block diagram of at least one embodiment of an environment of a child computing device of the system of FIG. 1;

FIG. 4 is a simplified flow diagram of at least one embodiment of a method to enable access to an application on the child computing device that may be executed by the parent computing device of FIGS. 1 and 2; and

FIG. 5 is a simplified flow diagram of at least one embodiment of a method to enable access to an application that may be executed by the child computing device of FIGS. 1 and 3.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

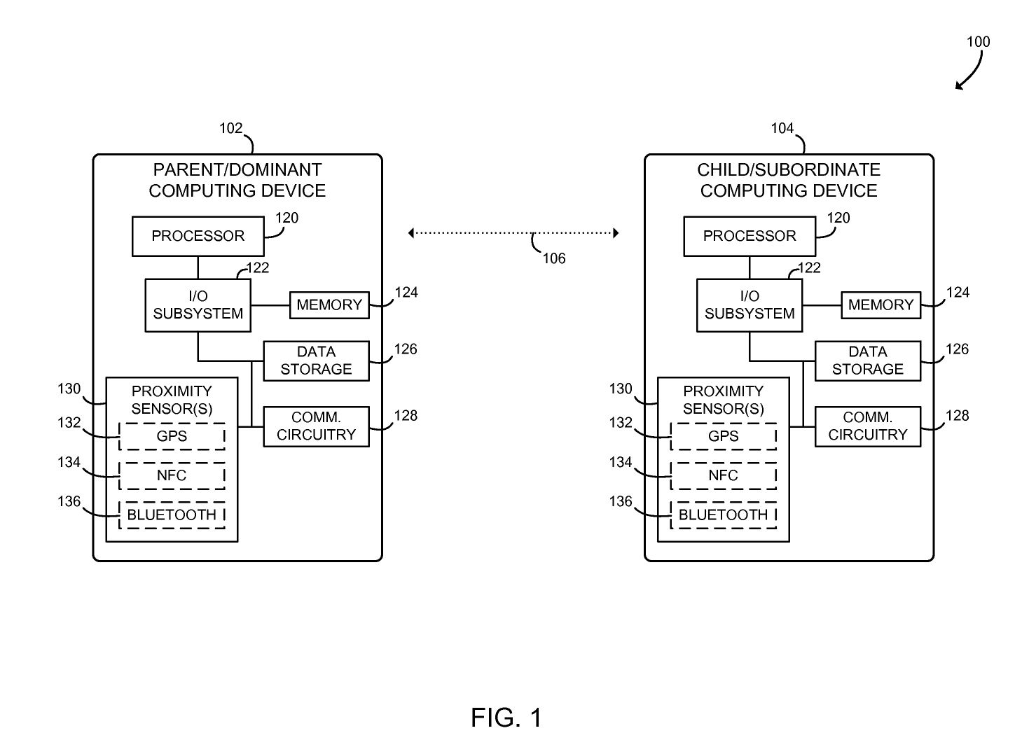

Referring now to FIG. 1, in one embodiment, a system 100 for proximity-based parental controls includes a parent computing device 102 and a child computing device 104. In use, as discussed in more detail below, the parent computing device 102 and the child computing device 104 communicate with each other to pair to each other in a conventional manner such that each device 102, 104 is configured to recognize and authenticate the other device 102, 104. Such pairing allows the parent computing device 102 to control operation of the child computing device 104 as discussed in more detail below. For example, once paired, the child computing device 104 enables access to an application in response to the parent computing device 102 being brought within a reference proximity 106 (or visa-versa). In some embodiments, the reference proximity 106 may represent a physical distance between the two devices. In other embodiments, the reference proximity 106 may represent a logical proximity between the two devices. In some embodiments, the child computing device 104 may enforce an access control policy created and configured on the parent computing device 102.

The parental control system 100 allows for simple and intuitive parent controls over the child computing device 104. The parent grants access to the application of the child computing device 104 through the natural action of placing the parent computing device 102 within proximity of the child computing device 104. The parent may revoke access through the natural action of taking the parent computing device 102 away from the child computing device 104. Such parental controls may be managed without operating potentially complicated or intrusive user interfaces on the child computing device 104.

The parent computing device 102 may be embodied as any type of computing device capable of performing the functions described herein. For example, the parent computing device 102 may be embodied as a mobile computing device such as a smart phone, a cellular phone, tablet computer, notebook computer, laptop computer, personal digital assistant, a mobile internet device, a vehicle (e.g., an infotainment system), or other mobile computing device. Alternatively, the parent computing device 102 may be embodied as a substantially stationary computing device such as a desktop computer, a gaming console, a smart appliance, a television set-top box, or other stationary or substantially stationary computing device.

Although the computing device 102 is referred to herein as a “parent” device, it should be appreciated that the parent computing device 102 may be embodied as any dominant computing device capable of controlling and/or communicating with the “child” or subordinate computing device 104. Additionally, although the user of the parent computing device 102 is referred to herein as a “parent,” such user may have any relationship (or no relationship) to the user of the child computing device 104 (i.e., the user of the parent computing device 102 need not be an actual “parent” of the user of the child computing device 104).

As shown in FIG. 1, the illustrative parent computing device 102 includes a processor 120, a memory 124, an input/output subsystem 122, a communication circuit 128, and a data storage device 126. Of course, the parent computing device 102 may include other or additional components, such as those commonly found in a mobile device and/or computer (e.g., various input/output devices), in other embodiments. Additionally, in some embodiments, one or more of the illustrative components may be incorporated in, or otherwise from a portion of, another component. For example, the memory 124, or portions thereof, may be incorporated in the processor 120 in some embodiments.

The processor 120 may be embodied as any type of processor capable of performing the functions described herein. For example, the processor 120 may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the parent computing device 102 such as operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the parent computing device 102. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processor 120, the memory 124, and other components of the parent computing device 102, on a single integrated circuit chip.

The communication circuit 128 of the parent computing device 102 may be embodied as any communication circuit, device, or collection thereof, capable of enabling communications between the parent computing device 102 and the child computing device 104 and/or other remote devices. The communication circuit 128 may be configured to use any one or more communication technology (e.g., wireless or wired communications) and associated protocols (e.g., Ethernet, Bluetooth®, Wi-Fi®, WiMAX, etc.) to effect such communication.

The data storage device 126 may be embodied as any type of device or devices configured for short-term or long-term storage of data such as, for example, memory devices and circuits, memory cards, hard disk drives, solid-state drives, or other data storage devices. In some embodiments, the parent computing device 102 may store in the data storage device 126 a shared secret established during pairing with the child computing device 104. Additionally, in some embodiments, the parent computing device 102 may store an access control policy in the data storage device 126.

In the illustrative embodiment, the parent computing device 102 also includes one or more proximity sensor(s) 130. Such proximity sensor(s) 130 may be embodied as any sensor, circuit, or other device capable of providing data indicative of the proximity of the parent computing device 102 to the child computing device 104. For example, in some embodiments, the proximity sensor(s) 130 may be embodied as, or otherwise include, a global positioning system (“GPS”) receiver 132, near-field communication (“NFC”) circuitry 134, and/or Bluetooth® circuitry 136. Such proximity sensor(s) 130 may be integrated with the communication circuitry 128 in some embodiments. Of course, it should be appreciated that the parent computing device 102 may include additional or other proximity sensors in other embodiments.

The GPS receiver 132 may be capable of determining the precise coordinates of the parent computing device 102. The GPS receiver 132 may be usable to determine the proximity of the child computing device 104 by comparing the location of the parent computing device 102 determined by the GPS receiver 132 to the location reported by the child computing device 104. It should be apparent to one skilled in the art that alternative location determination circuits may be used as proximity sensor(s) 130. For example, the location of the parent computing device 102 may be determined by triangulation using distances or angles to cellular network towers with known positions, or may be determined approximately based on association to wireless networks with known positions. Additionally, in embodiments in which the child computing device 104 is stationary, the street address of the child computing device 104 may be configured and stored, and subsequently translated to GPS coordinates or other Earth location parameters.

The NFC circuitry 134 allows for short-ranged radio communication with another device equipped with complementary NFC circuitry. The NFC circuitry 134 may be embodied as relatively short-ranged, high-frequency wireless communication circuitry. The NFC circuitry 134 may implement standards such as ECMA-340/ISO/IEC 18092, and/or ECMA-352/ISO/IEC 21481. The NFC circuitry 134 may allow for communication ranges on the order of a few centimeters. Given this short range, the NFC circuitry 134 may be usable to determine the proximity of the child computing device 104 by establishing a connection between the devices.

The Bluetooth® circuitry 136 may be embodied as a standard network adaptor for the Bluetooth® wireless communications protocol. Bluetooth® establishes wireless communications between devices using relatively low-power, short-range radio communications. The Bluetooth® circuitry 136 may allow for communication ranges on the order of a few meters. For this reason, Bluetooth® is often referred to as a personal area network communication technology. Given this short range, the Bluetooth® circuitry 136 may be useable to determine the proximity of the child computing device 104 by establishing a connection between the devices. It should be apparent to one skilled in the art that alternative personal area network technologies may also be used as proximity sensor(s) 130.

The child computing device 104 is configured to enable access to an application in response to determining the parent computing device 102 is in proximity, as discussed in more detail below. The child computing device 104 may be embodied as any type of computing device capable of performing the functions described herein. For example, the child computing device 104 may be embodied as a substantially stationary computing device such as a gaming console, a digital video player, a desktop computer, a smart television, a smart appliance, or other stationary computing device. Alternatively, the child computing device 104 may be embodied as a mobile computing device such as a smart phone, a mobile game console, a tablet computer, a laptop computer, and/or other mobile computing device.

The child computing device 104 may include components and features substantially similar to the parent computing device 102, which have been identified in FIG. 1 with common reference numbers. Accordingly, the descriptions provided above of the components of the parent computing device 102 are equally applicable to those similar components of the child computing device 104 and are not repeated herein so as not to obscure the present disclosure. Although the computing device 104 is referred to herein as a “child” computing device, it should be appreciated that the child computing device 104 may be embodied as any subordinate computing device capable of controlling access to an application thereon as discussed above. Additionally, although the user of the child computing device 104 is referred to herein as a “child,” such user may have any relationship (or no relationship) to the user of the parent computing device 102 (i.e., the user of the child computing device 104 need not be an actual “child” of the user of the parent computing device 102).

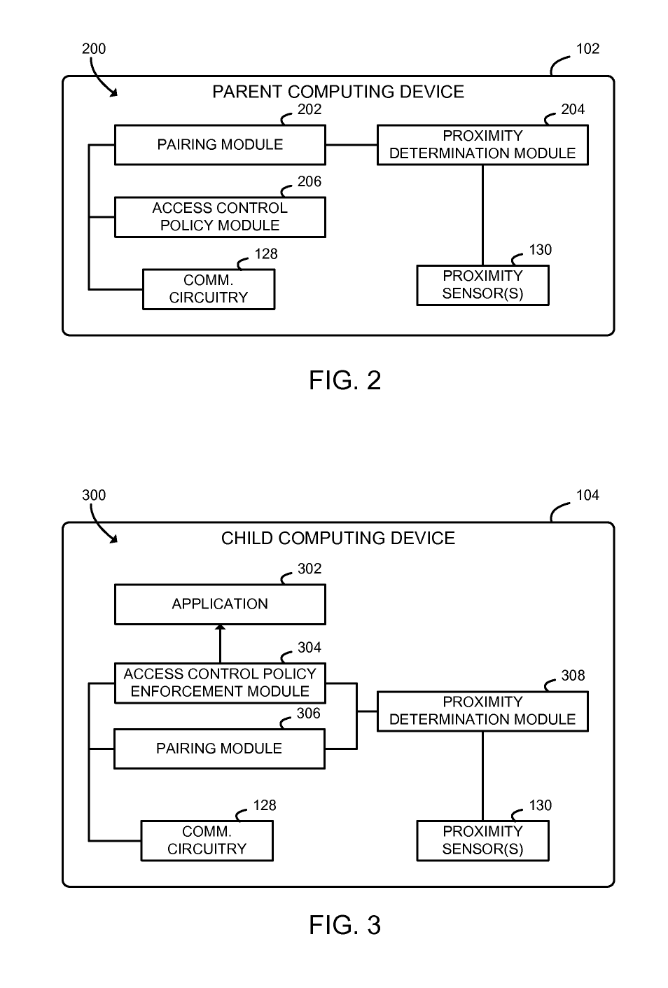

Referring now to FIG. 2, in one embodiment, the parent computing device 102 establishes an environment 200 during operation. The illustrative environment 200 includes a pairing module 202, a proximity determination module 204, and an access control policy module 206. The various modules of the environment 200 may be embodied as hardware, firmware, software, or a combination thereof.

The pairing module 202 is configured to pair the parent computing device 102 with the child computing device 104 to establish a shared secret. The pairing module 202 is further configured to authenticate the child computing device 104 using the shared secret when the devices are later determined to be in proximity with each other. The pairing module 202 communicates with the child computing device 104 using the communication circuitry 128. As discussed in more detail below, the pairing module 202 may employ any conventional pairing process.

The proximity determination module 204 is configured to determine whether the child computing device 104 is in proximity to the parent computing device 102. To make such determination, the proximity determination module 204 may interpret data received from the proximity sensor(s) 130. As discussed above, the pairing module 202 authenticates the child computing device 104 after the proximity determination module 204 determines the devices are in proximity. Furthermore, the pairing module 202 facilitates the authentication of the parent computing device 102 by the child computing device 104 as discussed in more detail below in regard to FIG. 3.

The access control policy module 206 is configured to send an access control authorization to the child computing device 104 in response to the proximity determination module 204 determining the child computing device 104 is in proximity and the pairing module 202 authenticating the child computing device 104. In some embodiments, the access control policy module 206 may configure an access control policy and send the access control policy to the child computing device 104.

Referring now to FIG. 3, in one embodiment, the child computing device 104 establishes an environment 300 during operation. The illustrative environment 300 includes an application 302, an access control policy enforcement module 304, a pairing module 306, and a proximity determination module 308. The various modules of the environment 300 may be embodied as hardware, firmware, software, or a combination thereof.

The application 302 may be embodied as any application capable of execution on the child computing device 104. For example, the application 302 may be embodied as a game, a video player, a web browser, or a particular web site. In some embodiments, the application 302 may be embodied as a user interface shell of the child computing device 104, for example, the desktop for traditional computers (e.g., Microsoft® Windows® Explorer), the application launcher for smart phones (e.g., iOS™ Springboard), or the game launcher for game consoles (e.g., Xbox® Dashboard). Enabling access to such user interface shell would effectively enable access to the child computing device 104, which may be desirable for dedicated-purpose embodiments of the child computing device 104. For example, if the child computing device 104 is embodied as a game console, allowing access to the user interface shell may allow the user to play any game on the child computing device 104.

The access control policy enforcement module 304 is configured to enable access to the application 302 in response to receiving an access control authorization from the parent computing device 102. In some embodiments, the access control policy enforcement module 304 may receive an access control policy associated with the application 302 from the parent computing device 102 and enforce that access control policy. The access control policy enforcement module 304 may be embodied as a standalone module as illustrated, or may be integrated into existing modules of the child computing device 104, such as access control modules of an operating system (not shown).

The pairing module 306 is configured to pair the child computing device 104 with the parent computing device 102 to establish a shared secret as discussed above. The pairing module 306 is additionally configured to authenticate the parent computing device 102 when the devices are later determined to be in proximity and prior to accepting any access control policy or otherwise allowing control of the child computing device 104 by the parent computing device 102. In this way, the child computing device 104 can ensure only an authorized parent computing device 102 is allowed control access to the child computing device 104. The pairing module 306 is further configured to authenticate the child computing device 104 to the parent computing device 102. As discussed in more detail below, the pairing module 306 may employ any conventional pairing process.

The proximity determination module 308 is configured to determine whether the parent computing device 102 is in proximity to the child computing device 104. To make such determination, the proximity determination module 308 may interpret data received from the proximity sensor(s) 130. As discussed above, the pairing module 306 authenticates the parent computing device 102 to the child computing device 104 after the proximity determination module 308 determines the devices are in proximity.

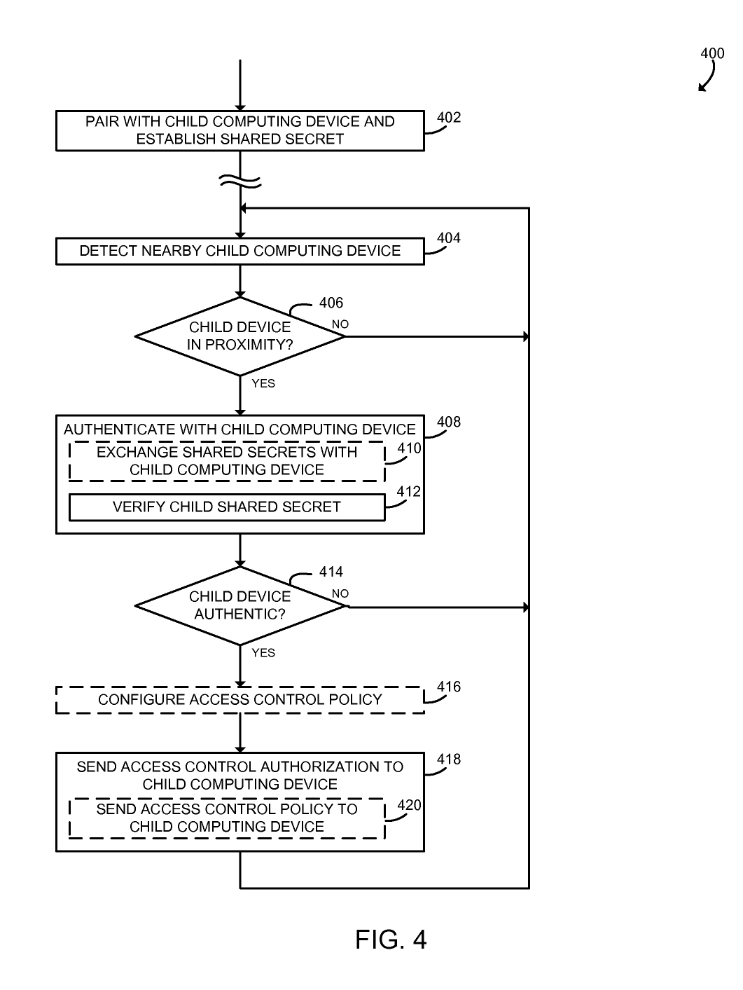

Referring now to FIG. 4, in use, the parent computing device 102 may execute a method 400 for enabling access to the application 302 of the child computing device 104. The method 400 begins with block 402, in which the pairing module 202 pairs with the child computing device 104. To do so, any suitable pairing process may be used. For example, the devices may pair using the Bluetooth® protocol or using NFC circuitry. As part of the pairing process, the parent computing device 102 and the child computing device 104 establish a shared secret. The shared secret may be embodied as, for example, a cryptographic certificate or a private key. The shared secret allows the pairing module 202 to authenticate the identity of the child computing device 104, and may allow for secure communication between the devices. The pairing process may be performed once to set up the parent computing device 102 and the child computing device 104; pairing may not be required after such initial set up procedure.

In block 404, the proximity determination module 204 attempts to determine the proximity of child computing device 104 using data received from the proximity sensor(s) 130. In some embodiments, the proximity determination module 204 may determine proximity using the same components used by the pairing module 202 to pair the devices. In some embodiments, the proximity determination module 204 may actively broadcast signals to the child computing device 104. For example, the proximity determination module 204 may energize the NFC circuitry 134 to attempt to establish a connection with the child computing device 104. In other embodiments, the proximity determination module 204 may passively listen for signals from the child computing device 104. For example, the Bluetooth® circuitry 136 may listen for attempted connections from the child computing device 104. In some embodiments, passive listening by the proximity determination module 204 may be used because the parent computing device 102 may have a limited power supply compared to the child computing device 104.

In block 406, the proximity determination module 204 determines whether the child computing device 104 is in proximity to the parent computing device 102. The threshold for proximity may depend on the type of the proximity sensor(s) 130 used and may depend on the desired behavior of the system 100. For example, when determining proximity using short-range communication sensors such as the NFC circuitry 134 or the Bluetooth® circuitry 136, the proximity determination module 204 may determine that the devices are in proximity if a connection is established. In other embodiments where proximity is determined based on the location of the devices, for example using the GPS receiver 132, the proximity determination module 204 may determine that the devices are in proximity if the devices are within a predefined distance of each other, for example, 10 meters. The predefined distance may be selected based on the accuracy of the GPS receiver 132 or the desired behavior of the system 100.

In other embodiments, the proximity determination module 204 may determine that the devices are in proximity based on a logical measure of proximity, such as network topology. The proximity determination module 204 may determine that the devices are in proximity if they are both connected to the same local network segment. For example, the proximity determination module 204 may determine whether the parent computing device 102 and the child computing device 104 are connected to the same wireless network, such as by comparing basic service set identification (BSSID). For wired networks, the proximity determination module 204 may determine whether the devices are connected to the same subnet, such as by using link-local addressing. Network-topology-based proximity determination is not strictly related to physical distance between the devices, but may provide a useful approximation of physical proximity for the purposes of this disclosure. If the proximity determination module 204 determines that the child computing device 104 is not in proximity, the method 400 loops back to block 404 to continue attempting to detect the child computing device 104. If the proximity determination module 204 determines that the child computing device 104 is in proximity, the method 400 advances to block 408.

In block 408, the pairing module 202 authenticates with the child computing device 104 (i.e., the parent computing device 102 authenticates to the child computing device 102 and authenticates the child computing device 102). To do so, in block 410, the pairing module 202 exchanges the shared secret with the child computing device 104 in some embodiments. As discussed above, the shared secret was previously established between the devices during the pairing process of block 402. In block 412, the pairing module 202 verifies the shared secret received from the child computing device 104 (and, similarly, the child computing device 104 verifies the shared secret transmitted by the parent computing device 102 as discussed below). Verifying the shared secret establishes that the child computing device 104 is the same device previously paired with the parent computing device 102. Verification may be embodied as comparing the shared secret received from the child computing device 104 in block 408 to the original shared secret established in block 402. In some embodiments, the shared secret may be verified without being received from the child computing device 104. For example, if the shared secret is an encryption key, the child computing device 104 may encrypt a message using the encryption key. If the parent computing device 102 is able to decrypt the message, then the child computing device 104 is in possession of the shared secret. In block 414, the method 400 determines whether the child computing device 104 is authentic; that is, whether the shared secret has been successfully verified. If the child computing device 104 is not authentic, the method 400 loops back to block 404, to continue attempting to detect the child computing device 104. If the child computing device 104 is authentic, the method 400 proceeds to block 416.

In block 416, in some embodiments, the access control policy module 206 may configure an access control policy for the application 302 of the child computing device 104. Such access control policy defines the allowed limits of use of the application 302 of the child computing device 104. For example, the access control policy may allow use of the application 302 while the parent computing device 102 remains in proximity to the child computing device 104. Alternatively, the access control policy may define an allowed usage time limit or an allowed time of day for the application 302. In some embodiments, the access control policy may define a content restriction for the application 302, for example, a rating restriction for movies, television shows, or video games. The access control policy module 206 may allow for interactive configuration of the access control policy using a user interface of the parent computing device 102. In some embodiments, the access control policy module 206 may allow a user of the parent computing device 102 to interactively configure the access control policy using a user interface of the parent computing device 102. Although illustrated as a step of the method 400 in the illustrative embodiment, in some embodiments, the access control policy may be configured ahead of time or configured with default policies.

In block 418, the access control policy module 206 sends an access control authorization to the child computing device 104. Such authorization indicates that the child computing device 104 is within proximity to the parent computing device 102 and has been successfully authenticated, and that access to the application 302 is allowed by any applicable access control policy. In response to receiving such authorization, the child computing device 104 enables access to the application 302. In block 420, in some embodiments, the access control policy module 206 sends the configured access control policy to the child computing device 104. The child computing device 104 controls access to the application 302 by enforcing the access control policy. In some embodiments, the access control policy may be sent to the child computing device 104 at a different time, for example, during initial configuration of the access control policy or during the pairing process of block 402.

After block 418, the method 400 loops back to block 404 to continue attempting to detect the child computing device 104. In some embodiments, such continued detection may allow the child computing device 104 to enforce an access control policy requiring continued proximity to the parent computing device 102 (i.e., all access to the application 302 only while the parent computing device 102 remains in proximity to the child computing device 104).

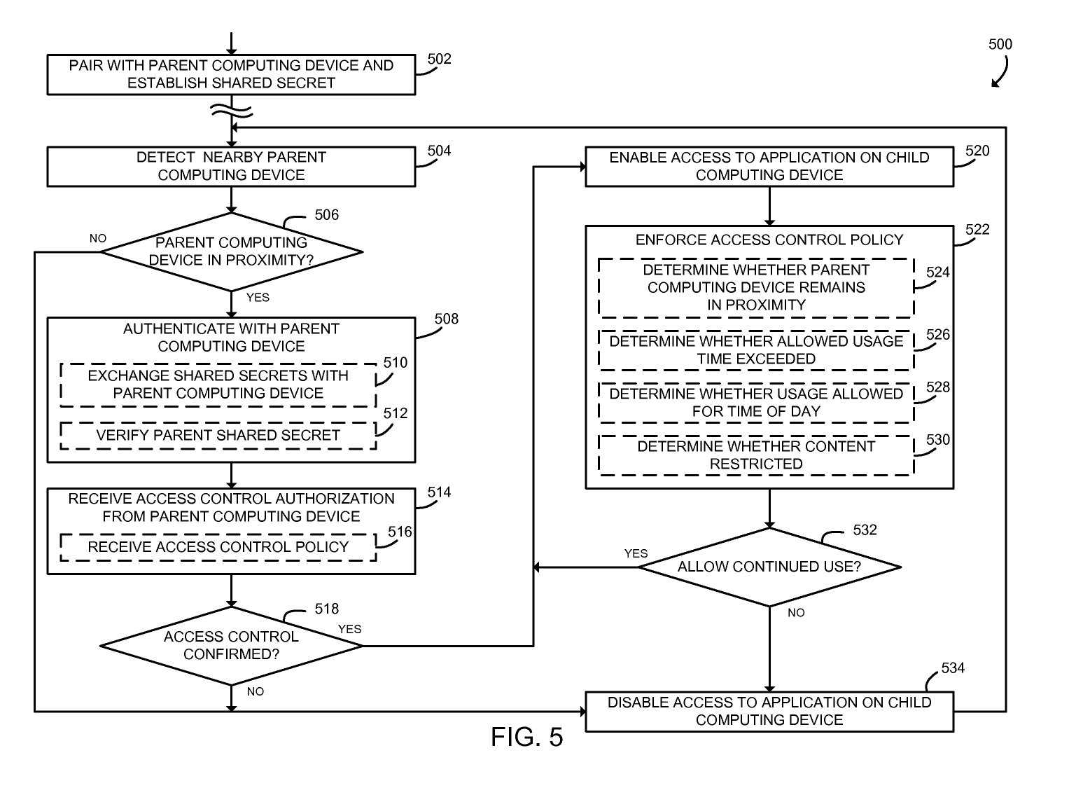

Referring now to FIG. 5, in use, the child computing device 104 may execute a method 500 for enabling access to the application 302 and enforcing an access control policy. The method 500 begins with block 502, in which the pairing module 306 pairs the child computing device 104 with the parent computing device 102. As part of the pairing process, the parent computing device 102 and the child computing device 104 establish a shared secret. As discussed above in connection with block 402, various conventional pairing processes may be employed.

In block 504, the proximity determination module 308 attempts to determine the proximity of the parent computing device 102 using data received from the proximity sensor(s) 130. As discussed above in connection with block 404, in some embodiments, the proximity determination module 308 may actively broadcast signals to the parent computing device 102, and in other embodiments the proximity determination module 308 may passively listen for signals from the parent computing device 102. In some embodiments, active broadcasting by the proximity determination module 308 may be used because the child computing device 104 may be a generally stationary computing device connected to an external power source, such as a game console.

In block 506, the proximity determination module 308 determines whether the parent computing device 102 is in proximity to the child computing device 104. Such determination is similar to the determination of block 406, described in more detail above. However, because the child computing device 104 may be stationary in some embodiments, the location of the child computing device 104 may be predefined or otherwise entered manually rather than detected using a location determination circuit. If the proximity determination module 308 determines that the parent computing device 102 is not in proximity, then the method 500 advances to block 530 to disable access to the application 302, discussed in more detail below. If the proximity determination module 308 determines that the parent computing device 102 is in proximity, then the method 500 advances to block 508.

In block 508, the pairing module 306 authenticates with the parent computing device 102 (i.e., the child computing device 104 authenticates the parent computing device 102 and authenticates to the parent computing device 104). To do so, in block 510, the pairing module 306 exchanges the shared secret with the parent computing device 102 as discussed above in regard to block 408 of method 400 (see FIG. 4). In block 512, the pairing module 306 verifies the shared secret received from the parent computing device 102 (and, similarly, the parent computing device 102 verifies the shared secret transmitted by the child computing device 104 as discussed above). Verifying the shared secret received from the parent computing device 102 establishes that the parent computing device 102 is the same device previously paired with the child computing device 104 and, as such, is authorized to control the access policies of the child computing device 104 as discussed in more below.

In block 514, the access control policy enforcement module 304 receives an access control authorization from the parent computing device 102. As discussed above in connection with block 418, such authorization indicates that the child computing device 104 is in proximity to the parent computing device 102, that the child computing device 104 successfully authenticated, and that access to the application 302 should be allowed. In some embodiments, in block 516, the access control policy enforcement module 304 may receive an access control policy for the application 302 from the parent computing device 102. In block 518, the child computing device 104 determines whether an access control authorization was successfully received. If not, the method 500 proceeds to block 534 to disable access to the application 302, as discussed in more detail below. If an access control authorization was successfully received, the method 500 advances to block 520.

In block 520, the access control policy enforcement module 304 enables access to the application 302. After access to the application 302 is granted, access may be controlled according to the access control policy. In block 522, the access control policy enforcement module 304 enforces the access control policy. The access control policy may have been received from the parent computing device 102. In some embodiments, the access control policy may be a default policy. In block 524, in some embodiments the access control policy enforcement module 304 determines whether the parent computing device 102 remains in proximity. Such access control policy allows the parent to control access to the application 302, for example, by removing the parent computing device 102 from proximity to the child computing device 104. In block 526, in some embodiments the access control policy enforcement module 304 determines whether an allowed usage time has been exceeded. For example, the access control policy may allow use of the application 302 for two hours. In block 528, in some embodiments the access control policy enforcement module 304 determines whether use of the application 302 is allowed for the current time of day. For example, the access control policy may allow usage of the application 302 in the evening hours. In some embodiments, the access control policy may define the allowed time of day based on the day of the week. For example, the access control policy may allow extended use on weekends but not weekdays. In block 530, in some embodiments the access control policy enforcement module 304 determines whether content is restricted by the access control policy. For example, the access control policy may allow access to movies, television shows, or video games bearing certain ratings.

In block 532, the access control policy enforcement module 304 determines whether to allow continued use of the application 302, based on the access control policy enforced in block 522. If continued use is allowed, the method 500 loops back to block 520 to enable access. If continued use is not allowed, the method 500 advances to block 534.

In block 534, the access control policy enforcement module 304 disables access to the application 302. As discussed above, access may be disabled in response to determining that the parent computing device 102 is not in proximity, failing to receive the access control authorization from the parent computing device 102, or enforcing the access control policy. Access to the application 302 may be disabled using any available technique: for example, the application 302 may be shut down, the interface to the child computing device 104 may be locked, or access to particular content through the application 302 may be denied. After disabling access to the application 302, the method 500 loops back to 504, to continue attempting to detect the parent computing device 102.

The illustrative parental control system 100 has been described above in regard to FIGS. 1-5 as including a single parent computing device 104 and a single child computing device 102. However, it should be appreciated that in other embodiments the system 100 may include multiple parent computing devices 104, each of which may be configured to control one or more child computing devices 104 (i.e., the pairing between the parent computing device 104 and the child computing device 104 may be a many-to-many paring). For example, a parent's mobile cellular phone and motor vehicle may be both embodied as a parent computing device 104 configured to control the child computing device(s) 102 (e.g., a smart phone or mobile game console). In such embodiments, an order of priority of the parent computing devices 104 may be established such that the child authenticates and authorizes a single parent computing device 102 at any one time. In the above example, the parent's motor vehicle may have a higher priority than the parent's mobile cellular phone, for example, such that the child computing device 102 is controlled by the motor vehicle when in proximity thereto regardless of whether the child computing device 102 is also in proximity to the parent's mobile cellular phone.

### EXAMPLES

Illustrative examples of the devices and methods disclosed herein are provided below. An embodiment of the devices and methods may include any one or more, and any combination of, the examples described below.

In Example 1, a dominant computing device includes a proximity determination module to determine whether a subordinate computing device is in a reference proximity to the dominant computing device as a function of data received from a proximity sensor of the dominant computing device; a pairing module to (i) pair the dominant computing device to the subordinate computing device to establish a shared secret therebetween and (ii) authenticate the subordinate computing device using the shared secret, in response to determining the subordinate computing device is in the reference proximity to the dominant computing device; and an access control policy module to send an authorization to the subordinate computing device in response to authenticating the subordinate computing device, the authorization to enable access to an application on the subordinate computing device.

Example 2 includes the subject matter of Example 1, wherein the access control policy module is further to configure an access control policy associated with the application; and send the access control policy to the subordinate computing device in response to authenticating the subordinate computing device.

Example 3 includes the subject matter of any of Examples 1 and 2, and wherein the access control policy comprises an allowed access duration for the application on the subordinate computing device.

Example 4 includes the subject matter of any of Examples 1-3, and wherein the access control policy comprises an allowed time of day for the application on the subordinate computing device.

Example 5 includes the subject matter of any of Examples 1-4, and wherein the access control policy comprises a content restriction for the application on the subordinate computing device.

Example 6 includes the subject matter of any of Examples 1-5, and wherein the proximity determination module is to determine whether the subordinate computing device is in the reference proximity by establishing a connection with the subordinate computing device using a near-field communication circuit of the dominant computing device.

Example 7 includes the subject matter of any of Examples 1-6, and wherein the proximity determination module is to determine whether the subordinate computing device is in the reference proximity by determining a first geographical location using a location determination circuit of the dominant computing device; receiving a second geographical location of the subordinate computing device; and comparing the first geographical location to the second geographical location.

Example 8 includes the subject matter of any of Examples 1-7, and the proximity determination module is to determine whether the subordinate computing device is in the reference proximity by establishing a personal area network connection with the subordinate computing device using a personal area network adaptor of the dominant computing device.

Example 9 includes the subject matter of any of Examples 1-8, and wherein the proximity determination module is to determine whether the subordinate computing device is in the reference proximity by determining a local network segment connected to the dominant computing device and determining whether the subordinate computing device is connected to the local network segment of the dominant computing device.

Example 10 includes a subordinate computing device to control access to an application available on the subordinate computing device. The subordinate computing device includes a proximity determination module to determine whether a dominant computing device is in a reference proximity to the subordinate computing device as a function of data received from a proximity sensor of the subordinate computing device; a pairing module to (i) pair the subordinate computing device to the dominant computing device to establish a shared secret therebetween and (ii) authenticate the dominant computing device to the subordinate computing device using the shared secret, in response to determining that the dominant computing device is in the reference proximity to the subordinate computing device; and an access control policy enforcement module to (i) receive an authorization from the dominant computing device in response to authenticating the subordinate computing device and (ii) enable access to the application in response to receiving the authorization from the dominant computing device.

Example 11 includes the subject matter of Example 10, and wherein the access control policy enforcement module is further to receive an access control policy associated with the application from the dominant computing device; and enforce the access control policy received from the dominant computing device in response to receiving the authorization.

Example 12 includes the subject matter of any of Examples 10-11, and wherein the proximity determination module is further to determine whether the dominant computing device is in the reference proximity to the subordinate computing device while access to the application is enabled; and the access control policy enforcement module is further to enforce the access control policy by disabling access to the application in response to determining that the dominant computing device is not in the reference proximity to the subordinate computing device.

Example 13 includes the subject matter of any of Examples 10-12, and wherein the access control policy comprises an allowed access duration; and the access control policy enforcement module is to enforce the access control policy by disabling access to the application after the expiration of the allowed access duration of the access control policy.

Example 14 includes the subject matter of any of Examples 10-13, and wherein the access control policy comprises an allowed time of day; and the access control policy enforcement module is to enforce the access control policy by disabling access to the application at a time of day not allowed by the access control policy.

Example 15 includes the subject matter of any of Examples 10-14, and wherein the access control policy comprises a content restriction; and the access control policy enforcement module is to enforce the access control policy by enforcing the content restriction of the access control policy.

Example 16 includes the subject matter of any of Examples 10-15, and wherein the proximity determination module is to determine whether the dominant computing device is in the reference proximity by establishing a connection with the dominant computing device using a near-field communication circuit of the subordinate computing device.

Example 17 includes the subject matter of any of Examples 10-16, and wherein the proximity determination module is to determine whether the dominant computing device is the reference in proximity by determining a first geographical location using a location determination circuit of the subordinate computing device; receiving a second geographical location of the dominant computing device; and comparing the first geographical location to the second geographical location.

Example 18 includes the subject matter of any of Examples 10-17, and wherein the proximity determination module is to determine whether the dominant computing device is in the reference proximity by establishing a personal area network connection with the dominant computing device using a personal area network adaptor of the subordinate computing device.

Example 19 includes the subject matter of any of Examples 10-18, and wherein the proximity determination module is to determine whether the dominant computing device is in the reference proximity by determining a local network segment connected to the subordinate computing device; and determining whether the dominant computing device is connected to the local network segment of the subordinate computing device.

Example 20 includes the subject matter of any of Examples 10-19, and wherein the application comprises one of: a user interface shell, a game, a web browser, and a web site displayed in a web browser.

Example 21 includes a method for enabling access to an application on a subordinate computing device using a dominant computing device. The method includes pairing the dominant computing device to the subordinate computing device to establish a shared secret therebetween; determining, on the dominant computing device, whether the subordinate computing device is in a reference proximity to the dominant computing device based on the pairing therebetween; authenticating, on the dominant computing device and in response to determining the subordinate computing device is in the reference proximity to the dominant computing device, the subordinate computing device using the shared secret; and sending, from the dominant computing device to the subordinate computing device, an authorization to enable access to the application on the subordinate computing device in response to authenticating the subordinate computing device.

Example 22 includes the subject matter of Example 21, and further includes configuring, on the dominant computing device, an access control policy associated with the application; and sending the access control policy from the dominant computing device to the subordinate computing device in response to authenticating the subordinate computing device.

Example 23 includes the subject matter of any of Examples 21 and 22, and wherein configuring the access control policy comprises defining an allowed access duration for the application on the subordinate computing device.

Example 24 includes the subject matter of any of Examples 21-23, and wherein configuring the access control policy comprises defining an allowed time of day for the application on the subordinate computing device.

Example 25 includes the subject matter of any of Examples 21-24, and wherein configuring the access control policy comprises defining a content restriction for the application on the subordinate computing device.

Example 26 includes the subject matter of any of Examples 21-25, and wherein determining whether the subordinate computing device is in the reference proximity comprises establishing a connection with the subordinate computing device using near-field communication.

Example 27 includes the subject matter of any of Examples 21-26, and wherein determining whether the subordinate computing device is in reference proximity comprises: determining, on the dominant computing device, a first geographical location of the dominant computing device; receiving, on the dominant computing device, a second geographical location of the subordinate computing device; and comparing, on the dominant computing device, the first geographical location to the second geographical location.

Example 28 includes the subject matter of any of Examples 21-27, and wherein determining whether the subordinate computing device is in reference proximity comprises establishing a personal area network connection between the dominant computing device and the subordinate computing device.

Example 29 includes the subject matter of any of Examples 21-28, and wherein determining whether the subordinate computing device is in proximity comprises determining a local network segment connected to the dominant computing device and determining whether the subordinate computing device is connected to the local network segment of the dominant computing device.

Example 30 includes a method for enabling access to an application on a subordinate computing device. The method includes pairing the subordinate computing device to a dominant computing device to establish a shared secret therebetween; determining, on the subordinate computing device, whether the dominant computing device is in a reference proximity to the subordinate computing device based on the pairing therebetween; authenticating the dominant computing device to the subordinate computing device using the shared secret, in response to determining that the dominant computing device is in the reference proximity to the subordinate computing device; receiving, on the subordinate computing device, an authorization from the dominant computing device in response to authenticating the subordinate computing device; and enabling access to the application on the subordinate computing device in response to receiving the authorization from the dominant computing device.

Example 31 includes the subject matter of Example 30, and further includes receiving, on the subordinate computing device, an access control policy associated with the application from the dominant computing device; and enforcing, on the subordinate computing device, the access control policy received from the dominant computing device in response to receiving the authorization.

Example 32 includes the subject matter of any of Examples 30 and 31, and wherein enforcing the access control policy comprises determining whether the dominant computing device is in the reference proximity to the subordinate computing device while access to the application is enabled; and disabling access to the application in response to determining that the dominant computing device is not in the reference proximity to the subordinate computing device.

Example 33 includes the subject matter of any of Examples 30-32, and wherein enforcing the access control policy comprises disabling access to the application after expiration of an allowed access duration of the access control policy.

Example 34 includes the subject matter of any of Examples 30-33, and wherein enforcing the access control policy comprises disabling access to the application at a time of day not allowed by the access control policy.

Example 35 includes the subject matter of any of Examples 30-34, and wherein enforcing the access control policy comprises enforcing a content restriction of the access control policy.

Example 36 includes the subject matter of any of Examples 30-35, and wherein determining whether the dominant computing device is in the reference proximity comprises establishing a connection with the dominant computing device using near-field communication.

Example 37 includes the subject matter of any of Examples 30-36, and wherein determining whether the dominant computing device is in the reference proximity comprises determining, on the subordinate computing device, a first geographical location of the subordinate computing device; receiving, on the subordinate computing device, a second geographical location of the dominant computing device; and comparing, on the subordinate computing device, the first geographical location to the second geographical location.

Example 38 includes the subject matter of any of Examples 30-37, and wherein determining whether the dominant computing device is in the reference proximity comprises establishing a personal area network connection between the subordinate computing device and the dominant computing device.

Example 39 includes the subject matter of any of Examples 30-38, and wherein determining whether the dominant computing device is in the reference proximity comprises determining a local network segment connected to the subordinate computing device; and determining whether the dominant computing device is connected to the local network segment of the subordinate computing device.

Example 40 includes the subject matter of any of Examples 30-39, and wherein enabling access to the application comprises one of: enabling access to a user interface shell, enabling access to a game, enabling access to a web browser, and enabling access to a web site displayed in a web browser.

Example 40 includes a computing device having a processor and a memory having stored therein a plurality of instructions that when executed by the processor cause the computing device to perform the method of any of Examples 21-40.

Example 41 includes one or more machine readable storage media comprising a plurality of instructions stored thereon that in response to being executed result in a computing device performing the method of any of Examples 21-40.

1. A dominant computing device, comprising:
a proximity determination module to determine whether a subordinate computing device is in a reference proximity to the dominant computing device as a function of data received from a proximity sensor of the dominant computing device;
a pairing module to (i) pair the dominant computing device to the subordinate computing device to establish a shared secret therebetween and (ii) authenticate the subordinate computing device using the shared secret, in response to determining the subordinate computing device is in the reference proximity to the dominant computing device; and
an access control policy module to send an authorization to the subordinate computing device in response to authenticating the subordinate computing device, the authorization to enable access to an application on the subordinate computing device.

2. The dominant computing device of claim 1, wherein the access control policy module is further to:
configure an access control policy associated with the application; and
send the access control policy to the subordinate computing device in response to authenticating the subordinate computing device.

3. The dominant computing device of claim 1, wherein the proximity determination module is to determine whether the subordinate computing device is in the reference proximity by establishing a connection with the subordinate computing device using a near-field communication circuit of the dominant computing device.

4. The dominant computing device of claim 1, wherein the proximity determination module is to determine whether the subordinate computing device is in the reference proximity by:
determining a first geographical location using a location determination circuit of the dominant computing device;
receiving a second geographical location of the subordinate computing device; and
comparing the first geographical location to the second geographical location.

5. The dominant computing device of claim 1, wherein the proximity determination module is to determine whether the subordinate computing device is in the reference proximity by establishing a personal area network connection with the subordinate computing device using a personal area network adaptor of the dominant computing device.

6. A subordinate computing device to control access to an application available on the subordinate computing device, comprising:
a proximity determination module to determine whether a dominant computing device is in a reference proximity to the subordinate computing device as a function of data received from a proximity sensor of the subordinate computing device;
a pairing module to (i) pair the subordinate computing device to the dominant computing device to establish a shared secret therebetween and (ii) authenticate the dominant computing device to the subordinate computing device using the shared secret, in response to determining that the dominant computing device is in the reference proximity to the subordinate computing device; and
an access control policy enforcement module to (i) receive an authorization from the dominant computing device in response to authenticating the subordinate computing device and (ii) enable access to the application in response to receiving the authorization from the dominant computing device.

7. The subordinate computing device of claim 6, wherein the access control policy enforcement module is further to:
receive an access control policy associated with the application from the dominant computing device; and
enforce the access control policy received from the dominant computing device in response to receiving the authorization.

8. The subordinate computing device of claim 7, wherein:
the proximity determination module is further to determine whether the dominant computing device is in the reference proximity to the subordinate computing device while access to the application is enabled; and
the access control policy enforcement module is further to enforce the access control policy by disabling access to the application in response to determining that the dominant computing device is not in the reference proximity to the subordinate computing device.

9. The subordinate computing device of claim 6, wherein the proximity determination module is to determine whether the dominant computing device is in the reference proximity by establishing a connection with the dominant computing device using a near-field communication circuit of the subordinate computing device.

10. The subordinate computing device of claim 6, wherein the proximity determination module is to determine whether the dominant computing device is the reference in proximity by:
determining a first geographical location using a location determination circuit of the subordinate computing device;
receiving a second geographical location of the dominant computing device; and
comparing the first geographical location to the second geographical location.

11. The subordinate computing device of claim 6, wherein the proximity determination module is to determine whether the dominant computing device is in the reference proximity by establishing a personal area network connection with the dominant computing device using a personal area network adaptor of the subordinate computing device.

12. A method for enabling access to an application on a subordinate computing device, the method comprising:
pairing the subordinate computing device to a dominant computing device to establish a shared secret therebetween;
determining, on the subordinate computing device, whether the dominant computing device is in a reference proximity to the subordinate computing device based on the pairing therebetween;
authenticating the dominant computing device to the subordinate computing device using the shared secret, in response to determining that the dominant computing device is in the reference proximity to the subordinate computing device;
receiving, on the subordinate computing device, an authorization from the dominant computing device in response to authenticating the subordinate computing device; and
enabling access to the application on the subordinate computing device in response to receiving the authorization from the dominant computing device.

13. The method of claim 12, further comprising:
receiving, on the subordinate computing device, an access control policy associated with the application from the dominant computing device; and
enforcing, on the subordinate computing device, the access control policy received from the dominant computing device in response to receiving the authorization.

14. The method of claim 13, wherein enforcing the access control policy comprises:
determining whether the dominant computing device is in the reference proximity to the subordinate computing device while access to the application is enabled; and
disabling access to the application in response to determining that the dominant computing device is not in the reference proximity to the subordinate computing device.

15. The method of claim 12, wherein determining whether the dominant computing device is in the reference proximity comprises establishing a connection with the dominant computing device using near-field communication.

16. The method of claim 12, wherein determining whether the dominant computing device is in the reference proximity comprises:
determining, on the subordinate computing device, a first geographical location of the subordinate computing device;
receiving, on the subordinate computing device, a second geographical location of the dominant computing device; and
comparing, on the subordinate computing device, the first geographical location to the second geographical location.

17. The method of claim 12, wherein determining whether the dominant computing device is in the reference proximity comprises establishing a personal area network connection between the subordinate computing device and the dominant computing device.

18. One or more non-transitory, machine readable media comprising a plurality of instructions that in response to being executed result in a subordinate computing device:
pairing the subordinate computing device to a dominant computing device to establish a shared secret therebetween;
determining, on the subordinate computing device, whether the dominant computing device is in a reference proximity to the subordinate computing device based on the pairing therebetween;
authenticating the dominant computing device to the subordinate computing device using the shared secret, in response to determining that the dominant computing device is in the reference proximity to the subordinate computing device;
receiving, on the subordinate computing device, an authorization from the dominant computing device in response to authenticating the subordinate computing device; and
enabling access to the application on the subordinate computing device in response to receiving the authorization from the dominant computing device.

19. The machine readable media of claim 18, further comprising a plurality of instructions that in response to being executed result in the subordinate computing device:
receiving, on the subordinate computing device, an access control policy associated with the application from the dominant computing device; and
enforcing, on the subordinate computing device, the access control policy received from the dominant computing device in response to receiving the authorization.

20. The machine readable media of claim 19, wherein enforcing the access control policy comprises:
determining whether the dominant computing device is in the reference proximity to the subordinate computing device while access to the application is enabled; and
disabling access to the application in response to determining that the dominant computing device is not in the reference proximity to the subordinate computing device.

21. The machine readable media of claim 18, wherein determining whether the dominant computing device is in the reference proximity comprises establishing a connection with the dominant computing device using near-field communication.

22. The machine readable media of claim 18, wherein determining whether the dominant computing device is in the reference proximity comprises:
determining, on the subordinate computing device, a first geographical location of the subordinate computing device;
receiving, on the subordinate computing device, a second geographical location of the dominant computing device; and
comparing, on the subordinate computing device, the first geographical location to the second geographical location.

23. The machine readable media of claim 18, wherein determining whether the dominant computing device is in the reference proximity comprises establishing a personal area network connection between the subordinate computing device and the dominant computing device.
